(19) United States
(12) Patent Application Publication
(10) Pub. No.: US 2021/0065942 A1
(43) Pub. Date: Mar. 4, 2021

(54) METHOD FOR THE PRODUCTION OF A SOFT MAGNETIC FORMED PART AND SOFT MAGNETIC FORMED PART

(71) Applicant: QUERDENKFABRIK AG, Thun (CH)

(72) Inventor: Thomas BÜTSCHI, Reutigen (CH)

(21) Appl. No.: 16/956,770

(22) PCT Filed: Dec. 21, 2018
(86) PCT No.: PCT/EP2018/086520

§ 371 Date: Jun. 22, 2020

(30) Foreign Application Priority Data
Dec. 22, 2017 (EP) 17209979.8

(51) Int. Cl. H01F 1/24; B22F 3/105; H01F 41/16

(52) U.S. Cl. CPC H01F 1/24; H01F 41/16; B22F 3/1055

(57) ABSTRACT

Disclosed is a method for producing a soft magnetic formed part, in which, according to the first aspect, magnetically conductive particles are melted such that electrical insulating locations are arranged locally in the interspaces interrupting eddy currents which arise when the formed part is used in a magnetic field. According to a second aspect, layers are formed from the particles in the presence of an additive, the layers are locally heated by an energy supply, or a blank is formed from the particles and the additive, the blank being heated by an energy supply. The energy supply is temporally concentrated such that the magnetically conductive particles at least surface-fuse and form a structure with interspaces, in which electrical insulating locations are formed on the basis of the additive.

The invention relates to a method for the production of a soft magnetic formed part and a soft magnetic formed part.

Soft magnetic substances are ferromagnetic materials which can be easily magnetized in a magnetic field. If formed parts made of such a substance, e.g. in the form of stator parts, are exposed to an external magnetic alternating field, a recurring magnetic reversal occurs. This results in magnetic reversal losses. In the case of electrically conductive formed parts, some of these losses are due to the induced eddy currents. In order to reduce the magnetic reversal losses, it is known to produce the formed parts from iron particles, which are completely surrounded by an electrical insulating layer to prevent current flow. For the manufacture of the formed part, the insulated iron particles are brought into the desired form by pressing and sintering in the furnace. This production method has several disadvantages:
There is a shrinkage, which can be in the range of 15-20%. Shrinkage is difficult to take into account, as it usually has a non-linear behavior.
If large quantities are to be manufactured with the desired quality, elaborate measures must be taken to guarantee a stable and accurate process, such as calibrating after sintering.
The particles isolated over the entire surface are only fused together on the outer surface of a formed part, but on the inside they form a relatively loose compound, so that the formed part is relatively brittle and a mechanical post-processing by means of a tool is difficult or even impossible.
The maximum achievable density, which the formed parts made from the completely insulated iron particles have, is limited.
The production costs are high, among other things, due to the long processing time and the high energy consumption.

DE 10 2014 006 519 A1 describes a method for the production of complex, magnetic and/or magnetizable formed parts using additive fabricators. No measures are provided to keep the specific electrical resistance of the formed parts low.

One object of the present invention is to specify a method of soft magnetic formed parts with improved properties.

A method that solves this problem is specified in claim 1 or 2. The further claims specify preferred embodiments as well as a formed part, which can be produced in particular by the method according to the invention.

According to a first aspect, magnetically conductive particles, which are free of a sheathing of an electrical insulating layer, are fused together in such a way that electrical insulating locations are locally arranged in the interspaces.

According to a second aspect, magnetically conductive particles are at least surface-fused by an energy supply. The energy supply is temporally concentrated and typically occurs in less than 1 second. Electrical insulating locations are formed in the interspaces due to an additive. These reduce in particular the eddy currents during magnetic reversal. The magnetically conductive particles do not necessarily have to be covered with a complete coating of an insulating layer. As a result, a high density can be achieved.

The electrical insulating locations, which are created during the method according to the first or second aspect, are formed island-like on the inside of the magnetic flux conducting formed part. The respective insulating location of the formed part has a current-interrupting effect. If the formed part is exposed to a magnetic field that changes over time, eddy currents are avoided or at least reduced, since a current flow through the insulating locations is interrupted. Iron losses can thus be reduced.

In a first embodiment, the formed part is produced in layers. Preferably an application device is provided to apply additional additives to a layer in a targeted manner. This allows the production of a formed part, which has a targeted inhomogeneous distribution of electrical insulating locations, in order to be able to conduct the magnetic flux B in a desired direction when used as a stator part.

In a second embodiment, the production is carried out by adiabatic pressing. This method makes it possible to produce formed parts in a short production time.

The fusion of the material, e.g. powder, takes place by means of an energy strike or several successive energy strikes. The at least one energy strike is carried out by means of a ram, for example. A particular advantage of the short-term energy introduced into the material, e.g. powder, is that the working temperatures in the formed part are typically less than 100° C. This means that additives with a low melting point can also be used as insulators, e.g. organic additives, which normally diffuse in the sintering process.

Preferably a negative form is used, which is filled with the magnetic particles and the additive, wherein the void space between the particles is reduced prior to adiabatic pressing, for example by mechanical means and/or by suctioning of air. In a special embodiment, the step of void space reduction is carried out by means of the punch, which is subsequently used as a ram for adiabatic pressing.

The invention is explained in the following by means of exemplary embodiments with reference to figures.

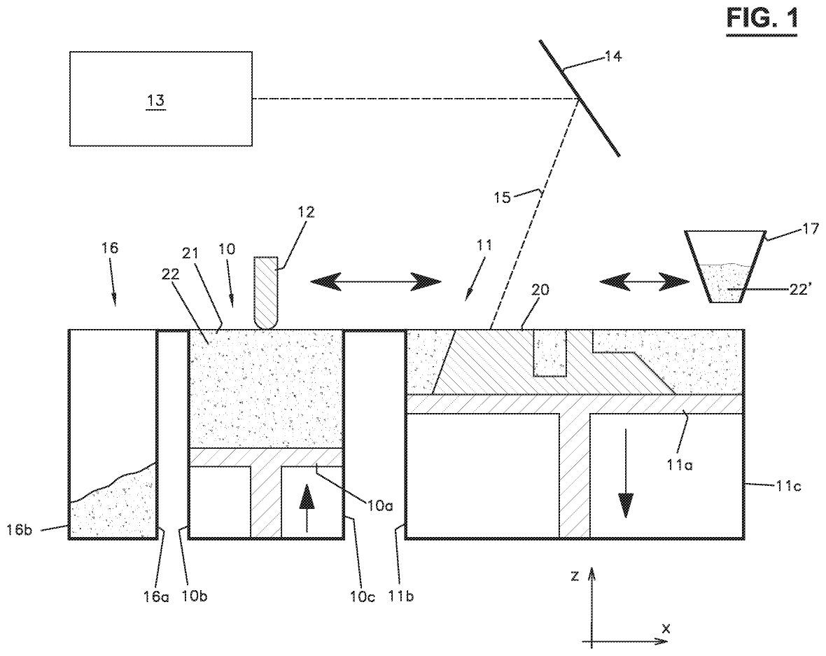

FIG. 1 shows schematically an example of a system for the production of a soft magnetic formed part,

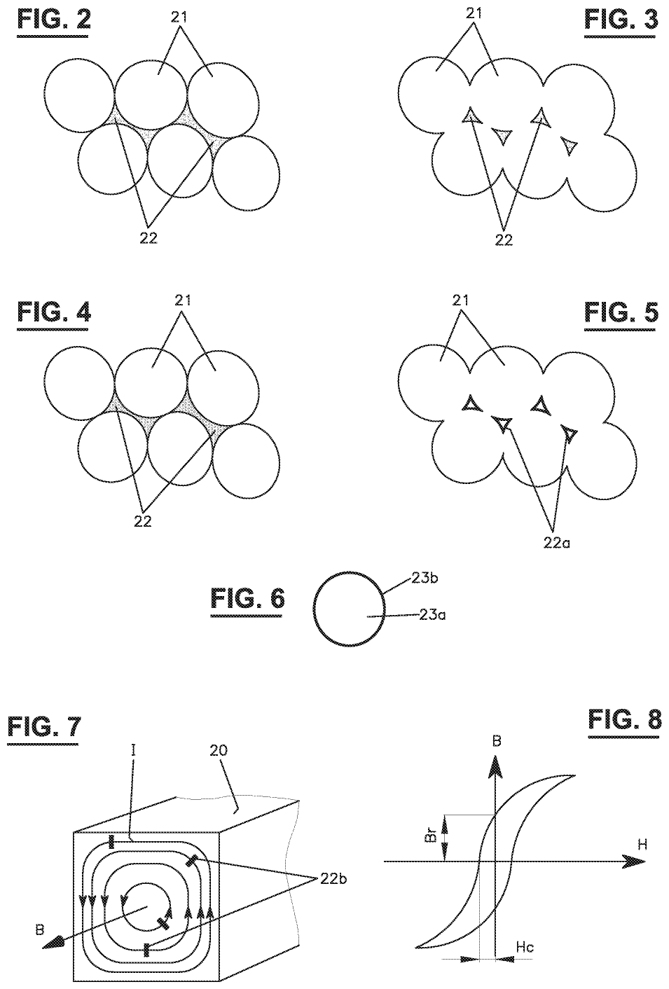

FIG. 2 shows a detailed view of a mixture which can be used for the production of a soft magnetic formed part before heating,

FIG. 3 shows the mixture according to FIG. 2 after heating,

FIG. 4 shows a detailed view of another mixture which can be used for the production of a soft magnetic formed part before heating,

FIG. 5 shows the mixture according to FIG. 4 after heating,

FIG. 6 shows a single iron particle which is completely covered with an electrical insulating layer,

FIG. 7 shows a formed part exposed to a magnetic field made of magnetically conductive particles, which is only partially provided with electrical insulating locations,

FIG. 8 shows a typical hysteresis curve of a formed part, which shows its magnetic flux density B as a function of the surrounding magnetic field H,

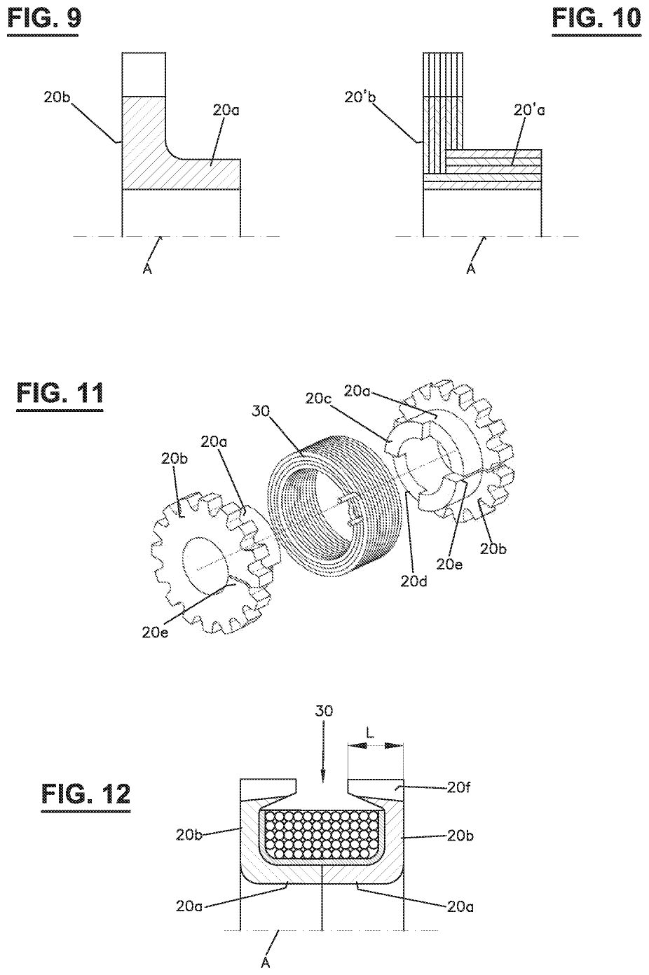

FIG. 9 shows an example of a stator part in a longitudinal section,

FIG. 10 shows a stator part, manufactured according to the prior art, in a longitudinal section,

FIG. 11 shows an exploded view of an embodiment of a stator,

FIG. 12 shows a cross section of another embodiment of a stator,

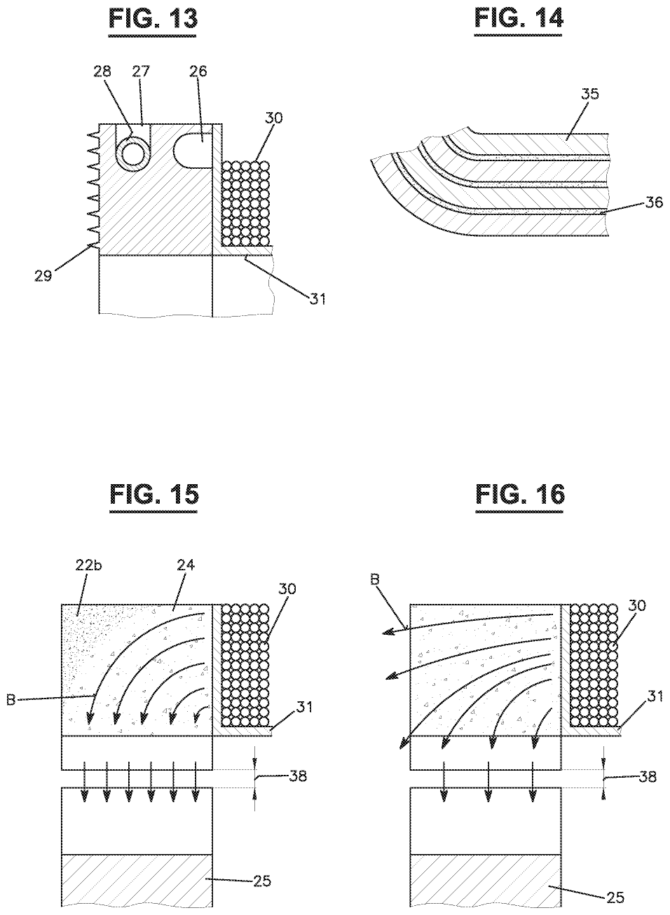

FIG. 13 shows a cross section of a variant of the stator with inner channels and cooling ribs,

FIG. 14 shows a 3D sheet metal structure in cross section,

FIG. 15 shows a cross section of a further embodiment of a rotor and a stator with targeted flow deflection, and

FIG. 16 shows a cross section of an embodiment of a rotor and a stator without specific flow deflection.

FIG. 1 schematically shows a system which is designed for the production of soft magnetic formed parts and which is constructed similar to a system for selective laser sintering. FIG. 1 shows the X and Z axes, which define the sectional plane in which the system is represented. The Y axis extends transversely to these two axes X and Z.

The system comprises a reservoir 10 for the intake and supply of the base material 21, 22, a manufacturing bed 11 in which the formed part 20 is manufactured, a coater 12 for the formation of a layer of the base material 21, 22 in the manufacturing bed 11, a laser 13 and a scanning device 14.

The reservoir 10 has a bottom 10a which can be lifted in the Z-direction and which for example, is part of a sliding piston.

The manufacturing bed 11 has a working platform 11a which can be lowered in the Z-direction and which is part of a sliding piston, for example.

The coater 12 is movable along the manufacturing bed 11, i.e. in X-direction, and is formed, for example, as a rotating roll or wiper.

The laser 13 and the scanning device 14 are designed for generating a laser beam 15, which is used for a local and temporally concentrated heating of a layer of the base material in the manufacturing bed 11. The laser 13 generates a beam that is typically in the infrared range. A CO₂ laser or an Nd:YAG laser, for example, are suitable as lasers.

The scanning device 14 comprises optical members, one or more lenses and one or more mirrors, for example, and serves to focus or expand the beam generated by the laser 13, if necessary, and to guide it along a predetermined path in the manufacturing bed 11, which defines the form of the formed part 20 at the level at which the layer is heated.

A further reservoir 16 serves as a silo, from which base material 21, 22 can be transferred to the reservoir 10 and/or unused base material 21, 22 can be taken up from the manufacturing bed 11.

The reservoir 10, the manufacturing bed 11 and the reservoir 16 are delimited by walls 10b, 10c, 11b, 11c, 16a, 16b. These are connected at front and back, i.e. seen in Y-direction by further walls (not to be seen in FIG. 1) and/or are circular in form, each resulting in a laterally closed chamber.

One possible method of producing a soft magnetic formed part 20 is as follows:

Geometric data are provided, which define the desired geometry of the formed part to be manufactured. These geometric data are available as CAD data, for example, and define the path along which the laser beam 15 is to be guided in each layer.

The base material 21, 22 is provided in the reservoir 10. For example, a mixture of magnetically conductive particles 21 and an additive 22 is used as the base material to form electrical insulating locations 22. In the finished formed part 20, these serve to interrupt or at least reduce eddy currents that occur during the magnetic reversal. The mixture is available, for example, in a pourable form, wherein the additive 22 is preferably present as particles. It is also conceivable to provide the additive 22 in pasty, liquid or gaseous form, so that it is in contact at least with the layer which has been formed from the magnetically conductive particles 21 in the manufacturing bed 11 and which is heated with the laser beam 15.

The magnetically conductive particles 21 are available as powder and/or granules. The respective particle 21 is preferably present in pure form, wherein the particles 21 can consist of different materials and thus form a mixture.

Suitable as material for the magnetically conductive particles 21 is, for example the following (content data in the following in percent by weight):
Iron (Fe)
Nickel (Ni)
Cobalt (Co)
Silicon iron mixture. The silicon content is, i.e., in the range from 2.5 to 4%, for example at 3%.
Nickel-iron mixture. The nickel content is, i.e., in the range from 8 to 30%.
Cobalt-iron mixture. The cobalt content is, i.e., in the range from 10 to 50%.

Other mixtures can also be provided, which comprise at least two of the following substances:
Iron
Silicon
Cobalt
Nickel
Aluminum
Copper
Tin
Antimony
Boron
Arsenic
Bismuth
Chromium oxide
Ferrites

Preferably, the magnetically conductive particles 21 are free from a complete coating by an electrically insulating layer.

The following substances are suitable as additive 22:
Silicone
Germanium
Wax, in particular N, N′-ethylene bis stearamide (amide wax, which is available, for example, under the name Acrawax C, Lonza AG, Basel, Switzerland). The melting point is below 200 degrees Celsius and/or 150 degrees Celsius.
Aluminum oxide
Carbon
Ceramics
Glass
Gas, which leads to an oxide layer between the particles 21 when heated by the laser beam 15. The following are e.g. suitable as such gases: Sulfur hexafluoride (SF₆), mixture of nitrogen (N₂) and sulfur hexafluoride (e.g. 80% nitrogen and 20% sulfur hexafluoride).
Thermoplastic, for example, polyvinyl chloride (PVC), polyether sulfone (PES), polycarbonate (PC).

The additive 22 can be present as particles whose grain size is smaller than that of the magnetically conductive particles 21. The median value (d₅₀) of the grain size distribution of the additive 22 is then smaller than the median value (d₅₀) of the grain size distribution of the magnetically conductive particles 21. It is also conceivable that the additive 22 is present as particles with a grain size that is at least as large as that of the magnetically conductive particles 21.

The bottom 10a is raised and a layer is formed on the work platform 11a by means of the coater 12. The layer is continuous and extends in the XY-plane according to FIG. 1. It typically has a thickness in the range of 1 to 200 micrometers. Using the geometry data, the laser beam 15 is guided along the desired path. The base material 21, 22 is heated at the corresponding locations, so that the magnetically conductive particles 21 connect with one another. By suitable adjustment of the energy input by the laser beam 15, the magnetically conductive particles 21 are fused and the additive 22 forms electrical insulating locations in the interspaces between the magnetically conductive particles 21. This is shown schematically in FIGS. 2 and 3 as well as 4 and 5, which show a layer with magnetically conductive particles 21 and additive 22 before and after heating. As can be seen from FIGS. 3 and 5, respectively, the magnetically conductive particles 21 have connected in the contact area; however, their structure is substantially preserved.

The energy of laser 13 can be introduced very quickly, so that an inclusion of additive 22 in the interspaces takes place. FIG. 3 shows the situation in which additive 22 has a higher melting temperature than the magnetically conductive particles 21, so that it is not melted by the laser beam 22. FIG. 5 shows the situation where the additive 22 has the same or a lower melting temperature than the magnetically conductive particles 21, so that it is melted by the laser beam 22 and forms an insulating layer 22a in the respective interspace of the magnetically conductive particles 21.

Depending on its choice, for example as a gas, the additive 22 can lead to a surface change of the magnetically conductive particles 21 during heating, so that an oxide layer is formed in the interspaces, which act as electrical insulating locations. Optionally, the manufacturing bed 11 is located in a closed chamber, to which the additive 22 is supplied as a gas. It is also conceivable that the additive 22 is first in solid form (for example as Acrawax) and melts when heated, so that a gas is produced, which causes the formation of an oxide layer in the respective interspace.

The working platform 11a is lowered by a layer thickness after the heating. The bottom 10a is raised and a next layer of base material 21, 22 is applied in the manufacturing bed 11 by means of the coater 12. The heating is then carried out again at the predetermined locations by means of the laser beam 15.

The finished formed part 20 is produced by successively applying a layer and heating.

During the manufacture, the formed part 20 is embedded in the manufacturing bed 11 in the rest of the base material 21, 22 which has not been heated by means of the laser beam 15. At the end of the manufacture, the formed part 20 is removed from the manufacturing bed 11 and any base material 21, 22 still adhering to it is knocked off, brushed off and/or removed in some other way.

In the method described so far, each layer has an essentially homogeneous concentration of base material 21, 22. The formed part 20 has accordingly an essentially homogeneous distribution of the electrical insulating locations. In one embodiment of the production method, a formed part 20 can be manufactured, which has a locally different distribution of insulating locations. For this purpose, the system according to FIG. 1 is provided with an application device in the form of a movable working head 17, by means of which a further additive 22′ can be applied at predetermined locations on a layer formed by the coater 12 before the layer is heated by means of the laser beam 15. The working head 17 is formed, for example, as a spray or print head, by means of which the further additive 22′ can be applied at predetermined locations, for example, in solid or liquid form. The further additive 22′ in the working head 17 can, for example, correspond to the additive 22 or be another suitable material which forms electrical insulating locations in the formed part 20 after the heating.

In addition to the method described so far, other methods are also suitable for producing soft magnetic formed parts. For example, from DE 10 2013 021 944 A1, additive manufacture is known, in which material is applied to predetermined locations by means of electrophotographic image drums. In addition to the manufacturing material, which in this case consists of magnetically conductive particles 21 and additive 22, a supporting material can also be applied in this method, which is removed after the manufacture of the formed part and is used, for example, to manufacture undercuts. At least three rollers are preferably provided here, by means of which magnetically conductive particles 21, additive 22 and support material can be applied. A manufacturing head for applying the magnetically conductive particles 21 has a fixing unit with a laser, by means of which energy can be transferred to the magnetically conductive particles 21 in a temporally concentrated manner, in order to generate a fusing. By arranging several manufacturing heads for the applying of production and support material one after the other, a production line can be provided, which enables an efficient manufacture of formed parts.

In addition to an additive manufacturing method, it is also conceivable to produce a formed part 20 in one piece by means of a so-called adiabatic forming/densification (“adiabatic pressing”). In a first process step, for example by pressing, a blank which corresponds to the desired form of the formed part 20 is manufactured from the mixture of magnetically conductive particles 21 and additive 22. The blank is not yet solidified, so that the particles may only bind minimally. An additional binder may be provided and/or the additive 22 itself acts as such a binder, for example in the case of silicone. In a second process step, the blank is then densified, so that it gets the desired hardness. In this case, energy of more than 5000 joules per mm³ and preferably more than 6000 joules per mm³ is introduced by means of at least one strike, which causes the particles 21 to fuse with one another. The impact is carried out, for example, by means of high-speed presses, as described, for example, in WO 2016/135187 A1, according to which a ram which is moved, for example, at more than 5 m/s acts on the blank. However, in this known method densification is followed by a sintering by heating in a furnace. Such a subsequent sintering is not provided here for fusing the powder grains.

The inventor has found that adiabatic pressing may cause the particles 21 to fuse together insufficiently and/or create unwanted air inclusions if there is too much void space between the material to be densified beforehand. A method step before adiabatic pressing is therefore preferably provided, in which the void space is reduced. The void space reduction is carried out without heat input and is achieved, for example, by the action of a punch, vibration, air extraction, application of a vacuum and/or other suitable measures.

Preferably, the void reduction step and the adiabatic pressing step are performed on the same machine. In one embodiment, the machine has a negative form, which defines the form of the formed part and is open at the top. The negative form is filled with the magnetically conductive particles and, if appropriate, also with the additive if the additive is present, for example, in solid or liquid form. The void space between the particles is reduced as mentioned above. In one embodiment, the punch is used for this purpose, which is later used as a ram for the adiabatic pressing, wherein it is moved much more slowly and with a smaller downstroke. This is followed by adiabatic pressing.

Depending on the form of the formed part to be produced, it is also conceivable to design the punch for the adiabatic pressing in several parts. This allows the parts of the punch to be moved with a different downstroke and thus to compensate for density differences in the formed part.

The production by means of adiabatic pressing makes it possible to produce formed parts with the desired geometrical dimensions. This means that post-processing is not necessary. Typically, the following geometrical accuracies can be achieved by means of adiabatic pressing, wherein the specifications specify the maximum deviation from the target value:
at most ±2%, preferably at most ±1% for a dimension in the pressing direction, i.e., in the direction in which the punch is moved
at most ±0.5%, preferably at most ±0.25% for a dimension transverse to the pressing direction. (This dimension is defined by the walls of the negative form and is therefore particularly precise.)

The advantage of adiabatic pressing as a production method as opposed to a production using an additive method is that a formed part can be produced in a shorter time and is therefore particularly suitable for economical production in large quantities.

The production method described here can be used to manufacture soft magnetic formed parts that typically have the following properties:
The formed part is not permanently magnetic.
The density of the formed part is better approximated to the density of the magnetically conductive particles. This can be achieved, inter alia, by using magnetically conductive particles in the base material which do not have a complete sheathing of an electrical insulating layer. FIG. 6 shows an example of an iron particle 23a which is completely provided with an insulating layer 23b. If a formed part is produced from such particles using the known sintering method, it is relatively porous on the inside and has a relatively high proportion of insulating material and also binder. Its density is reduced accordingly. The inventor has recognized that a complete insulating coating of the magnetically conductive particles is not necessary in order to avoid eddy current losses as far as possible, which occur during remagnetization of the soft magnetic formed part. It is sufficient if a magnetically conductive particle 21 is partially enclosed by an insulator barrier which interrupts the eddy current flow, as shown schematically in FIG. 7. A portion of the formed part 20 is represented there, in which eddy currents I try to flow in the plane transverse to the magnetic flux B. These are interrupted by the electrical insulating locations 22b that were formed due to the additive 22.
The formed part has a slim hysteresis curve and the hysteresis losses are reduced accordingly. In particular, the magnetic coercive field force H_{c} is small and the remanent flux density Bᵣ is large, cf. FIG. 8. Due to the increased flux density B, longer poles than usual can be realized for the stator parts and more installation space is available for the winding.
The relative density (density of the formed part compared to the density of the material of the magnetically conductive particles) is at least 90%.
Formed parts, which have the desired physical parameters, can be produced. Typically, the density ρ, the magnetic coercive field force H_{c} and the remanent flux density Bᵣ have a maximum deviation from the respective target value of at most ±3%, preferably at most ±2%.

The production methods described here have the advantage, in particular towards the known methods by sintering in the furnace, that formed parts with complex geometries can also be produced. For example, stator parts can be manufactured that are designed for a magnetic flux that should not only occur in one plane during operation, but in all three directions. FIGS. 9 and 10 each show a half of a stator part made of a flux tube 20a or 20′a and a serrated disk 20b or 20′b in a longitudinal section, where A describes the longitudinal axis. The stator part 20a, 20b according to FIG. 9 can be manufactured integrally with one of the production methods described here and allows the desired flux conduction to be achieved by appropriate design of the geometry. The magnetic flux can be diverted here in such a way that it is first aligned transversely to the axis A and then into this direction A. The stator part 20′a, 20′b represented in FIG. 10 is manufactured by means of the previously known production method, in that the flux tube 20′a has a layered structure and the disk part 20′b consists of a laminated core. The magnetic flux takes place in the flux tube 20′a and in the disk part 20′b in each case essentially in one direction.

FIG. 11 shows a perspective exploded view of an arrangement with two serrated disks 20b, each with an integrally attached part of the flux tube 20a. This is divided in such a way that, after mounting the coil 30, it can be plugged together in a defined position in which the teeth of the two disks 20b are aligned as desired. In the example, this is achieved, as with a claw coupling, by claws 20c which engage in recesses 20d on the opposite part. In this figure, a slot 20e is also visible in the respective stator part 20a, 20b, which avoids a ring closure during operation. The slot 20e can either be provided in the integral manufacture or it can be subsequently formed, for example by milling, since this allows the formed part due to its hardness.

The form of the teeth on the stator part can also be selected as desired. FIG. 12 shows, in longitudinal section, one half of the coil 30 as well as two serrated disks 20b, each with the integrally attached part of the flux tube 20a, wherein A is the rotor or stator axis. As can be seen, a tooth 20f of stator part 20a, 20b is formed in such a way that it protrudes inwards (compare length L in FIG. 12) and is therefore longer in the direction of axis A compared with, for example, the variant according to FIG. 10.

Stator parts can also be manufactured, which are provided with an inner cavity and/or integrally manufactured additional members. An example of such a stator part is shown in FIG. 13. The inner cavity 26 forms an inner channel through which air for cooling the coil 30 attached to the winding body 31 can be transported. The inner cavity 27 also forms an inner channel, but is provided with a tube 28, for example, for passing e.g. water for cooling. Cooling ribs 29 are also indicated in this figure.

Formed parts can also be manufactured, which have a targeted distribution of insulating locations. This allows the magnetic flux to be guided in such a way that it is not only in one direction, as is the case with the known lamination packages, but in several directions.

FIG. 14 shows an example which has layers of a soft magnetic material 35 and of insulation material 36. The layers 35 are formed, for example, from the base material 21, 22 which is used in the system according to FIG. 1. The insulation layers 36 are manufactured, for example, by means of the application device 17 shown in FIG. 1. A type of “3D sheet metal structure” can thus be formed which, as required, can expand not only in the plane but in all three directions, for example as indicated on the left in FIG. 14.

FIG. 15 shows an example in which the distribution of the electrical insulating locations 22b is inhomogeneous. Insulating locations 22b are concentrated here on the side of the stator pole 24 opposite to the coil 30. As a result, the magnetic flux B is diverted better, so that it reaches the rotor pole 25 to an increased extent via the air gap 38. Without this concentration of insulating locations 22b, part of the magnetic field emerges laterally from the stator pole, as is indicated in FIG. 16. Correspondingly, this results in unusable flux losses.

Further advantages of the production methods described here are as follows:
The temporally concentrated energy supply prevents the magnetically conductive particles from completely fusing with the adjacent particles. The provision, in particular, of a non-gaseous additive prevents the interspaces between the magnetically conductive particles from being filled up by molten material. Shrinkage behavior is easier to calculate, so that precise formed parts can be manufactured with the desired dimensions. Typically, formed parts can be manufactured with a form accuracy of better than ±0.2 mm. Post-processing is not absolutely necessary.
Soft magnetic formed parts with a high density can be produced. This is advantageous, for example, in order to be able to provide electric motors with high torque. For example, a stator part based on Fe can be produced with at least a density of 7.0 g/cm³, preferably at least 7.3 g/cm³ and particularly preferably at least 7.6 g/cm³. This is close to the density of Fe, which is 7.9 g/cm³.
The choice of materials is diverse. For example, by choosing iron and an additive, such as Acrawax, soft magnetic formed parts can be produced very inexpensively or by the selection of iron, cobalt and Acrawax formed parts with very good magnetic properties, especially those with a high remanent flux density Bᵣ.
The use of a combination of magnetically conductive particles and additive results in the fact that metal articles in the manufactured formed part are selectively electrically insulated. This is sufficient to generate a high specific electrical resistance and thus to effectively reduce the eddy currents that arise during magnetic reversal. It is therefore not absolutely necessary to provide expensive base materials, for example in the form of iron particles which are completely surrounded by an insulation layer.
Dimensionally stable formed parts can be produced. An additional binder, such as synthetic resins, does not necessarily have to be provided in the base material in order to connect the particles to one another. A manufactured formed part has a hardness that has sufficient cohesion of the particles, which, if necessary, permits mechanical processing, in particular subsequent material removal, for example by grinding, turning and/or milling. This enables a formed part to be manufactured with a high degree of dimensional accuracy, for example, in order to obtain an accurate and minimal air gap.
The geometry of the formed part can be selected as desired. For example, it can have one or more undercuts, means for cooling such as bores, ribs, channels, etc., means for precise positioning and/or centering such as cams, ribs, bores, etc.
Integral formed parts can be produced which can be used for various application purposes, e.g. parts of electric machines such as electric motors or generators, especially transverse flux machines or other electric machines such as those used e.g. in electric vehicles.

From the preceding description, numerous modifications are accessible to the person skilled in the art without leaving the scope of protection of the invention, defined by the claims.

1. A method for the production of a soft magnetic formed part which has inside electrical insulating locations to reduce eddy current losses, in which method magnetically conductive particles, which are free from a sheathing of an electrical insulating layer, are provided and, for the formation of the formed part, are fused to one another in such a way that the electrical insulating locations interrupting eddy currents, which arise when the formed part is used in a magnetic field, are arranged locally in the interspaces.

2. A method for the production of a soft magnetic formed part, in particular according to claim 1, in which magnetically conductive particles and an additive for the formation of electrical insulating locations are provided, wherein
layers are formed from the particles in the presence of the additive, which layers are heated locally by an energy supply, or
a blank which is heated by an energy supply is formed from the particles and the additive, wherein
the energy supply is temporally concentrated so that the magnetically conductive particles at least surface-fuse and form a structure with interspaces, in which electrical insulating locations are formed due to the additive.

3. The method of claim 2, which has at least one of the following features a-e:
a) the additive is provided in the form of particles, a paste or both,
b) the additive provided is liquid,
c) the additive provided is gaseous,
d) the additive in the interspaces acts as electrical insulating locations,
e) due to the additive, oxide layers are formed as electrical insulating locations in the interspaces.

4. The method according to claim 1, in which the magnetically conductive particles consist of a material with a density rho, the density of the formed part produced corresponding to at least 90% of the density rho.

5. The method according to claim 2, in which the temporally concentrated energy supply is effected by locally heating a layer by means of a laser beam or by adiabatic pressing of the blank.

6. The method according to claim 1, in which, by means of an application device for the formation of further electrical insulating locations a further additive is selectively applied to the layers in order to produce a formed part which has an inhomogeneous distribution of electrical insulating locations.

7. The method according to claim 1, in which additional material is applied for the formation of at least one member which is magnetically non-conductive.

8. The method according to claim 2, in which the formed part is postprocessed by material removal, which includes at least one of grinding, turning and milling.

9. The method according to claim 2, wherein the additive has at least one of the following characteristics A-C:
A) the additive is provided in the form of particles, the magnetically conductive particles and the additive being provided in the form of a mixture,
B) the additive is present in the form of particles whose grain size is smaller than that of the magnetically conductive particles,
C) the melting temperature of the additive is higher than the one of the magnetically conductive particles, so that the additive is substantially not melted in the interspaces by the temporally concentrated energy supply, or the melting temperature of the additive is at most as high as that of the magnetically conductive particles, so that the temporally concentrated energy supply changes the structure of the additive by forming electrically insulating layers in the interspaces.

10. The method according to claim 1, wherein the materials used for the production of the formed part are free from epoxy, phenolic and polyamide resins as binders.

11. The method according to claim 2, in which the magnetically conductive particles contain at least one of the following materials:
Iron
Silicon
Cobalt
Nickel
Aluminum
Copper
Tin
Antimony
Boron
Arsenic
Bismuth
Chromium oxide
Ferrites.

12. The method according to claim 2, wherein the additive comprises at least one of the following substances:
Silicone
Germanium
Wax
Thermoplastic
Aluminum oxide
Carbon
Ceramics
Glass
Gas or gas mixture to form an oxide layer.

13. The method according to claim 2, which is carried out on a system which has at least one of the following features M1-M7:
M1) at least one reservoir for receiving at least the magnetically conductive particles,
M2) a manufacturing bed with a working platform which can be moved layer by layer, in which bed the formed part is manufactured,
M3) at least one movable coater by means of which a layer which comprises magnetically conductive particles from a or the at least one reservoir can be formed in a or the manufacturing bed,
M4) at least one laser and at least one scanning device for generating and guiding the laser beam along a predetermined path,
M5) at least one application device, by means of which an additive for forming electrical insulating locations can be applied specifically to a respective layer,
M6) at least one negative form, which is at least partially complementary to the formed part,
M7) at least one punch for adiabatic pressing of a blank.

14. The method according to claim 2, in which the temporally concentrated energy supply is effected by adiabatic pressing of the blank, wherein, for the production of the blank, magnetically conductive particles and the additive are introduced into a negative form and, before the adiabatic pressing is carried out, the void space between the particles is reduced.

15. A soft magnetic formed part which serves as a stator or rotor part of an electrical machine and which is produced by the method according to claim 1, the formed part having at least one of the following features a-c:
a) The formed part has magnetically conductive regions which are made of a material with a density rho, the density of the formed part being at least 90% of the density rho.
b) The formed part is integrally manufactured and has at least one internal cavity.
c) The formed part is integrally manufactured and has an inhomogeneous distribution of electrical insulating locations.

16. The formed part according to claim 15, the density of which is greater than 7.0 grams per cubic centimeter.

17. The formed part according to claim 15, which includes at least one of an inner channel for cooling formed by the inner cavity and cooling ribs integrally manufactured.

18. The formed part according to claim 15, which is designed as a stator part with teeth which serve for the formation of poles.

19. The method according to claim 2, in which the magnetically conductive particles consist of a material with a density rho, the density of the formed part produced corresponding to at least 90% of the density rho.

20. The method according to claim 3, in which the magnetically conductive particles consist of a material with a density rho, the density of the formed part produced corresponding to at least 90% of the density rho.
